(19) United States
(12) Patent Application Publication
(10) Pub. No.: US 2023/0313610 A1
(43) Pub. Date: Oct. 5, 2023

(54) CHAIN SHROUD FOR ROLLER SHADE

(71) Applicant: ZMC Metal Coating, Inc., Woodbridge (CA)

(72) Inventor: Philip NG, Thornhill (CA)

(73) Assignee: ZMC Metal Coating, Inc., Woodbridge (CA)

(21) Appl. No.: 18/146,084

(22) Filed: Dec. 23, 2022

Related U.S. Application Data
(63) Continuation-in-part of application No. 17/729,314, filed on Apr. 26, 2022.

(30) Foreign Application Priority Data
Mar. 29, 2022 (CA) 3153589
Nov. 16, 2022 (CA) 3182048

(51) Int. Cl. E06B 9/78; E06B 9/40

(52) U.S. Cl. CPC E06B 9/78; E06B 9/40; E06B 2009/785

(57) ABSTRACT

A shroud for the drive chain of a roller blind. The drive chain has s a series of balls mounted on a cord or wire and is in the form of a pair of leg members forming a loop. The shroud comprises an elongate body having opposed open ends with an internal passageway extending therebetween. The body has an enclosed exterior surface extending between the open ends. A longitudinal internal baffle may extend between the open ends, segmenting the internal passageway into two longitudinal channels, each channel extending between the open ends and dimensioned to slidably receive one of the pair of chain leg members therethrough. The baffle may have a longitudinal slot extending along its length, where the slot is dimensioned to permit the receipt of the cord or wire of the drive chain, and is dimensioned to preclude the passage of the balls of the drive chain therethrough.

### CROSS REFERENCE TO RELATED APPLICATIONS

This patent application is a continuation-in-part of and claims priority on and the benefit of U.S. patent application Ser. No. 17/729,314 having a filing date of 26 Apr. 2022, and further claims priority on and the benefit of Canadian Patent Application No. 3153589 having a filing date of 29 Mar. 2022 and Canadian Patent Application No. 3182048 having a filing date of 16 Nov. 2022.

### BACKGROUND OF THE INVENTION

### Technical Field

This invention relates to the field of roller shades, and in particular to a new and novel shroud to encompass the operational chain or cord of a roller shade.

### Prior Art

Roller shades have become an increasingly common window covering and are used in both residential and commercial applications alike. Commonly, the shade fabric of a roller shade is raised or lowered through pulling on one end of a looped chain or cord that extends from a clutch or drive mechanism, typically located at or within the head rail of the roller blind, downwardly along the side of a window. While such mechanisms have proven to be a useful and efficient means to quickly and easily raise or lower the fabric of a roller shade in front of a window pane, it has been realized that in some instances the loop of chain or cord extending downwardly along the window frame can present a strangulation hazard for small children, and potentially pets. For that reason, many jurisdictions require the bottom looped end of the chain or cord to be rigidly secured to the window frame, making it difficult to be accessed by a small child. However, in spite of such regulations and the various structures that have been proposed to secure the ends of chains or cords to a window frame, in some applications there still exists the ability for a small child to potentially become entrapped between the two legs of a looped chain or cord, causing injury or death. Accordingly, there continues to exist a need for improved safety measures that can be used in conjunction with chains or cords that operate roller blinds.

### BRIEF SUMMARY OF THE INVENTION

In an embodiment there is presented a shroud for a drive chain of a roller blind, the drive chain comprising a series of generally spherical balls mounted in a spaced apart configuration on a cord or wire, the drive chain in the form of a pair of chain leg members joined together and forming a loop, the shroud comprising an elongate body having opposed open ends with a longitudinal internal passageway extending between the opposed open ends, the elongate body having a fully enclosed exterior surface extending between the open ends, a longitudinal internal baffle extending between the open ends and segmenting the longitudinal internal passageway into two longitudinal channels, each longitudinal channel extending between the open ends and dimensioned to slidably receive one of the pair of chain leg members therethrough, the longitudinal internal baffle having a longitudinal slot extending along its length, the slot dimensioned to permit the receipt of the cord or wire of the drive chain therethrough, the longitudinal slot dimensioned to preclude the passage of the balls of the drive chain therethrough.

In a further embodiment the invention comprises a shroud for a drive chain or cord of a roller blind, the drive chain or cord in the form of a pair of chain or cord leg members joined together and forming a loop, the shroud comprising an elongate body having opposed open ends with a longitudinal internal passageway extending between the opposed open ends, the elongate body having a fully enclosed exterior surface extending between the open ends, the longitudinal passageway dimensioned to slidably receive the pair of chain or cord leg members therethrough, wherein the pair of chain or cord leg members is receivable through the elongate passageway, wherein a lower end of each of the chain leg members extends through the same open end of the elongate body and the looped chain or cord leg members is slidably received by a chain retainer, wherein the shroud is received about the chain or cord leg members between the chain retainer and a drive mechanism of the roller blind.

In another embodiment there is provided a shroud for a drive chain or cord of a roller blind, in combination with a chain retainer, the drive chain or cord in the form of a pair of chain or cord leg members joined together and forming a loop, the shroud comprising an elongate body having opposed open ends with a longitudinal internal passageway extending between the open ends, the elongate body having a fully enclosed exterior surface extending between the open ends, the chain retainer slidably receiving the looped chain or cord leg members, wherein the pair of chain leg members are received through the longitudinal internal passageway of the elongate body, and wherein, when the drive chain or cord is oriented in a vertical configuration, the shroud has a resting position where it contacts the chain retainer, and a displaced position where it has been slid vertically upward along the chain or cord leg members to expose a length of the drive chain or cord between the shroud and the chain retainer.

### BRIEF DESCRIPTION OF THE DRAWINGS

For a better understanding of the present invention, and to show more clearly how it may be carried into effect, reference will now be made, by way of example, to the accompanying drawings which show exemplary embodiments of the present invention in which:

FIG. 1 is a side perspective view of a roller shade upon which is employed a shroud constructed in accordance with an embodiment of the invention.

FIG. 2 is an upper side perspective view of one embodiment of the shroud shown in FIG. 1.

FIG. 3 is an end view of the embodiment of the shroud shown in FIG. 2.

FIG. 4 is an upper side perspective view of a second embodiment of the shroud shown in FIG. 1.

FIG. 5 is an end view of the embodiment of the shroud shown in FIG. 4.

FIG. 6 is an upper side perspective view of a third embodiment of the shroud shown in FIG. 1.

FIG. 7 is an end view of the embodiment of the shroud shown in FIG. 6.

FIG. 8 is a view of the clutch/drive system of the roller shade of FIG. 1, having a drive chain secured thereto with the shroud removed.

FIG. 9 is a view similar to FIG. 8, wherein a shroud constructed in accordance with an embodiment of the invention has been received over the drive chain, and wherein the lower looped portion of the drive chain is shown secured by a chain retainer.

FIG. 10 is a view similar to FIG. 9, wherein the shroud has been lifted in an upward direction, exposing the lower portion of the drive chain.

FIG. 11 is an upper side perspective view of a roller shade upon which is employed a shroud constructed in accordance with an embodiment of invention which utilizes an alternate form of chain retainer.

FIG. 12 is an upper side perspective view of the chain retainer shown in FIG. 11.

FIG. 13 is a side elevational view of the chain retainer shown in FIG. 11.

FIG. 14 is a sectional view taken along the line 14-14 of FIG. 13.

### DETAILED DESCRIPTION OF PREFERRED EMBODIMENTS

The present invention may be embodied in a number of different forms. The specification and drawings that follow describe and disclose some of the specific forms of the invention.

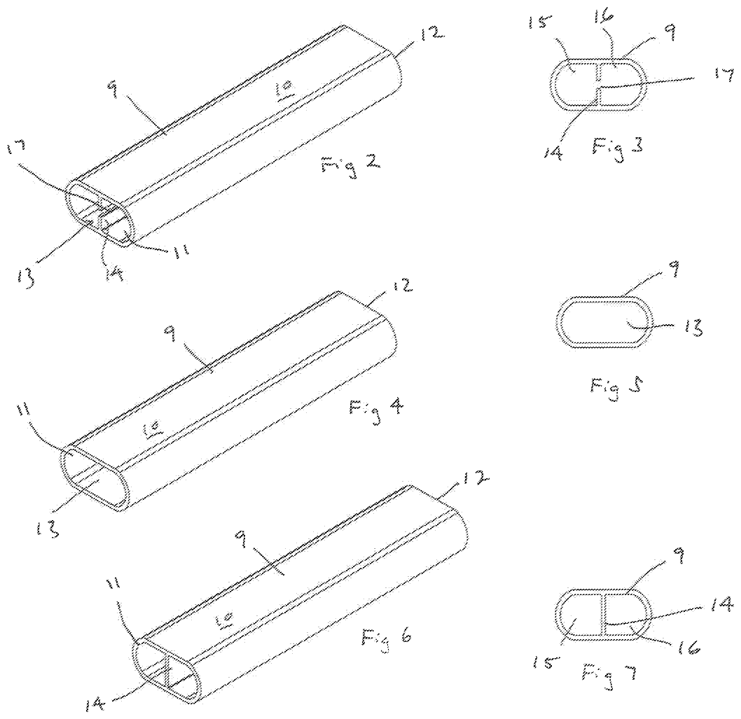

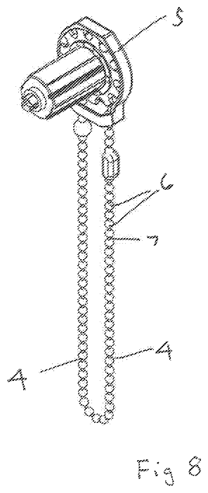

With reference to the attached drawings, there is shown a relatively generic roller shade 1 that is comprised generally of a head rail 2 and shade or blind fabric 3. As in the case of most common roller shades, blind fabric 3 is raised or lowered through pulling on one of a pair of chain or cord leg members 4 which are joined together to form a loop. With reference to FIG. 8, the looped chain or cord 4 is typically received around a clutch or drive mechanism 5, that is in turn secured or otherwise connected to a roller tube upon which blind fabric 3 is rolled or unrolled. Also as in the case of most roller blinds, pulling on one of the two chain or cord leg members 4 will cause the roller shade to be rotated in a first direction whereas pulling on the other chain or cord leg member will cause the roller tube to be rotated in an opposite direction, such that the blind fabric is either raised or lowered.

Where the blind is operated through use of a chain, the chain is typically comprised of a series of generally spherical shaped balls 6 that are mounted in a spaced apart configuration on a cord or wire 7. Typically balls 6 are spaced apart at an approximate equal distance to facilitate their engagement with the roller blind clutch. In other applications the blind is operated through the use of a looped cord. As is mandated by certain jurisdictions, the lower end of the looped roller chain may be commonly received through or otherwise retained by a chain retainer 8. It will be appreciated that chain retainer 8 could take any one of a very wide variety of different configurations and structures, and that its primary purpose is to maintain the chain along the side of a window frame in order to help prevent an infant, or perhaps a pet, from being entangled therein.

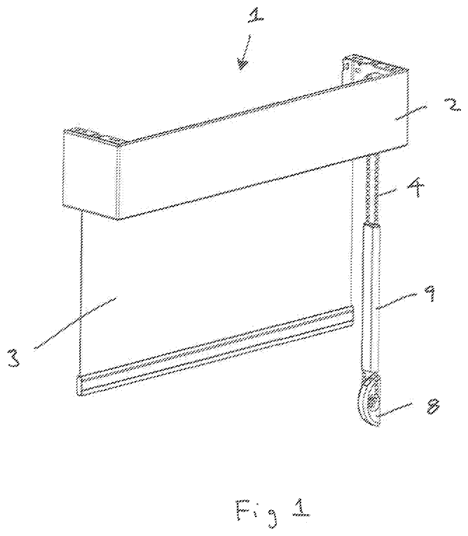

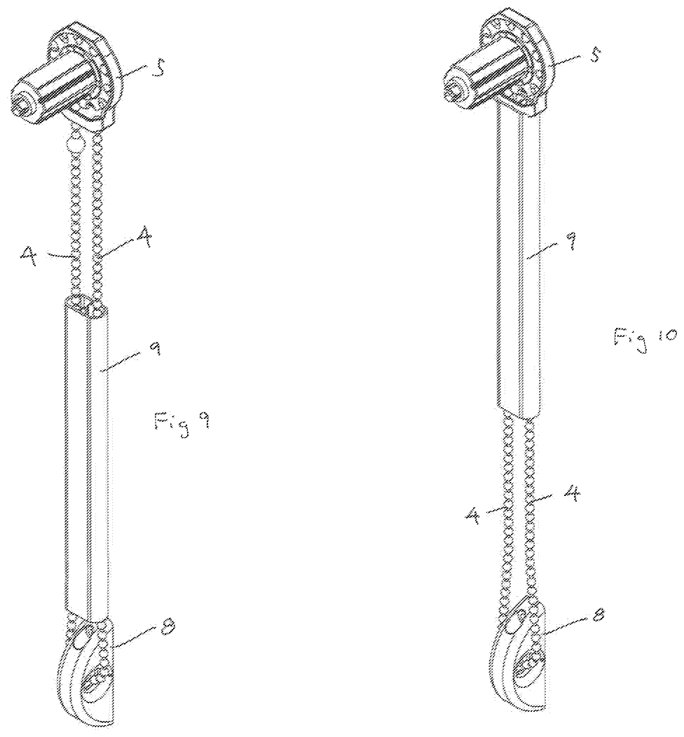

In accordance with the invention, there is provided a shroud 9 for chain leg members 4 that comprises an elongate body 10 having opposed open ends 11 and 12, respectively. Elongate body 10 has a fully enclosed exterior surface extending between open ends 11 and 12. In one embodiment, elongate body 10 is oblong in cross section. Elongate body 10 further comprises a longitudinal internal passageway 13 that extends between open ends 11 and 12, and through which chain leg members 4 can be slidably received. As shown specifically in FIGS. 1, 9 and 10, during operation, both of chain leg members 4 extend through internal passageway 13 with the lower ends of each chain member extending through open end 12 and then slidably secured to chain retainer 8. In this manner, shroud 9 is received about the chain leg members between chain retainer 8 and clutch 5. As demonstrated in FIG. 9, in a rest configuration, open end 12 contacts or rests against chain retainer 8, whereas in an alternate position shroud 9 may be lifted to the point where open end 11 is close to or contacts clutch 5, thereby exposing a portion of each of the pair of chain leg members immediately above chain retainer 8.

FIGS. 6 and 7 illustrate one embodiment of shroud 9. In this embodiment the shroud includes a longitudinal internal baffle 14 that extends between open ends 11 and 12, thereby segmenting longitudinal internal passageway 13 into two longitudinal channels, 15 and 16 respectively. Each of the longitudinal channels 15 and 16 thus extends between open ends 11 and 12 and is dimensioned to slidably receive one of the pair of chain leg members 4. In one instance, baffle 14 is a solid, longitudinally oriented, planar structure secured along opposed longitudinal edges thereof to opposite sides of an internal longitudinal surface of passageway 13 (see FIGS. 6 and 7). In an alternate configuration, baffle 14 may include a longitudinal slot 17 extending along its length (see FIGS. 2 and 3). Slot 17 is preferably dimensioned to permit to the receipt of cord or wire 7 therethrough, while at the same time precluding the passage of balls 6 through the slot where a balled chain or similar is utilized. That is, the slot is sized to allow shroud 9 to be received over a looped pair of chain leg members 4 by slidably engaging slot 17 with the looped pair of chain leg members between two adjacent balls.

FIGS. 4 and 5 illustrate yet a further embodiment of shroud 9 where internal passageway 13 is open and no baffle is utilized. In this embodiment the two chain leg members are merely inserted through internal passageway 13, after which the lower looped portion of the chain is secured or otherwise received about chain retainer 8.

Regardless of which of the particular embodiments of shroud 9 described above is utilized, it will be appreciated that when assembled over the drive chain or cord of a roller blind, between the drive mechanism or clutch and the chain retainer, shroud 9 will serve to effectively retain each of the chain leg members in a close relationship, thereby precluding an infant or pet from becoming entangled therewith. To operate the roller blind, an individual need only grasp the shroud and lift it vertically upward, sliding it along the drive chain and exposing a lower portion of the looped drive chain between the bottom of the shroud and the chain retainer. The desired leg of the chain that is exposed below the shroud can then be pulled in a downward direction to either deploy or retract the blind fabric from the roller blind. Once the blind fabric has been adjusted to its desired level, releasing the shroud allows it to slide back downwardly along both legs of the chain until it once again comes to rest on the chain retainer, and once again provides an effective means to prevent an infant or pet from becoming entangled in the two chain leg members.

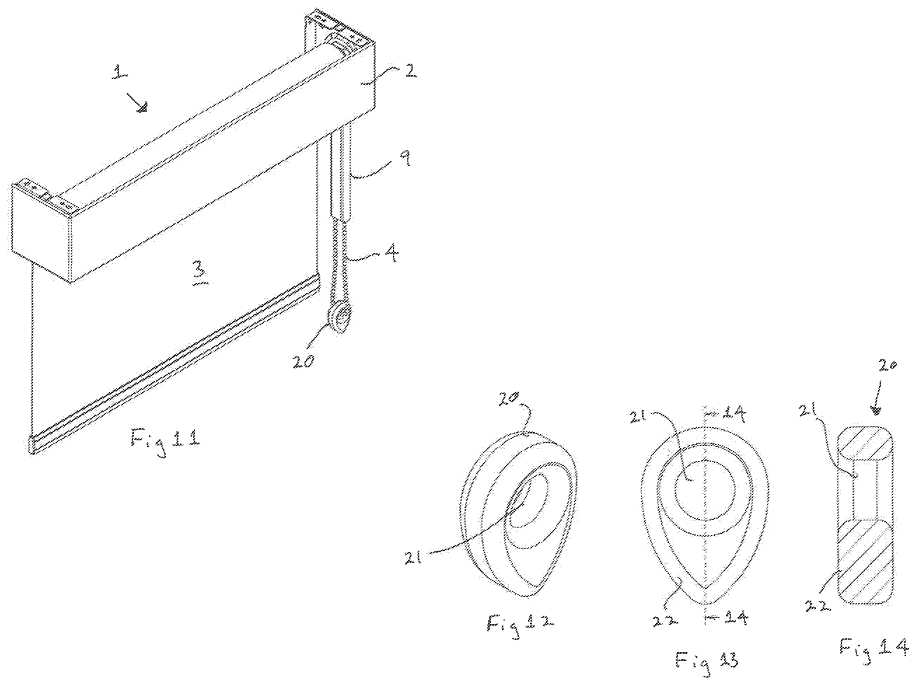

A further alternate embodiment of the invention is shown in FIGS. 11-14. In this embodiment, shroud 9 may take any one of the forms or embodiments described above, including any one of those shown in FIGS. 2 through 7. However, in this embodiment chain retainer 8 has been replaced with a ring-form chain retainer 20 which does not need to be securable to the frame of a window as would typically be the case when utilizing a chain retainer 8 in the form described above and as shown in the earlier drawings. Here, ring-form chain retainer 20 contains a hole or aperture 21 through which looped chain or cord 4 is received. Ring-form chain retainer 20 is of a size that is sufficient to prevent it from being pulled through internal passageway 13 of the elongate body 10 of shroud 9. That is, ring-form chain retainer 20 is of a sufficient size such that shroud 9 will rest upon its upper surface, effectively preventing access to chain or cord 4 until such time as shroud 9 is lifted vertically to expose the two opposed legs of chain or cord 4.

In an embodiment of the invention ring-form chain retainer 20 maybe of a teardrop shape wherein lower portion 22 has a more significant mass than the upper portion, thereby maintaining the chain retainer in a generally vertical orientation. The mass of ring-form chain retainer 20 will also tend to hold the two opposing legs or chain or cord 4 relatively vertical and taught along the side of the window frame. In this manner, shroud 9 will be encouraged to fall, under the act of gravity, downwardly until its lower-end rests upon the top of the ring-form chain retainer. The mass of the ring-form chain retainer will also help to ensure that the looped chain or cord 4 will remain relatively vertically-oriented when shroud 9 is grasped and slid upwardly along the chain or cord in order to expose the lower ends of the chain or cord and to permit operation of the roller blind. To facilitate movement of chain or cord 4 through hole or aperture 21, that portion of ring-form chain retainer 20 surrounding hole or aperture 21 may be beveled or angled, so that pulling on one leg of chain or cord 4 to operate the blind in one direction or the other, will permit the ring-form chain retainer to readily slide along the chain or cord 4 without becoming caught or hung up. Further, ring-form chain retainer 20 may be formed from a silicone, plastic or other type material that helps to minimize the generation of noise when chain or cord 4 slides through hole or aperture 21. Ultimately, ring-form chain retainer 20 may be constructed of other materials and may have a noise dampening on noise-reducing coating.

While the enclosed drawings show a ring-form chain retainer 20 in the general form of a teardrop shape, it will be appreciated that a very wide variety of other shapes and geometric configurations could equally be used while remaining within the broad scope of the invention. Further, if desired, the window frame within which blind 1 is mounted could contain a fastener or fastening mechanism that could also allow ring-form chain retainer to be releasably secured or otherwise releasably amounted to the window frame. end of insertion

It will further be appreciated that to minimize noise of operation, in an embodiment the shroud may be formed from a relatively soft plastic or plastic-like material having generally rounded edges that not only aid in reducing noise when coming into contact with a chain, but that also make the exterior of the shroud more comfortable to grasp by an individual. In other instances the shroud may be formed from wood or other natural material. It will further be appreciated that by forming the elongate body of the shroud with a fully enclosed exterior surface, the likelihood of an individual's hand becoming pinched between the shroud and the chain is minimized, noise that would otherwise be created through contact of the balls of the chain with holes or other openings in the exterior of the shroud is eliminated, a “cleaner” look is presented, and the ability for dust and debris to enter the shroud and to be deposited upon the chain is reduced. Where the shroud is formed from a plastic or plastic-like material, the described structure also presents the ability for the shroud to be formed through a single extrusion, thereby helping to minimize manufacturing costs. If desired, the shroud could be formed from a transparent or translucent material to minimize its visual appearance. In other cases the shroud may be coloured to match the colour of the window frame.

A further alternate embodiment of the invention is shown in FIGS. 11 through 14. In this embodiment, shroud 9 may take any one of the forms or embodiments described above, including any one of those shown in FIGS. 2 through 7. However, in this embodiment chain retainer 8 has been replaced with a ring-form chain retainer 20 which does not need to be secured to the frame of a window. Here, ring-form chain retainer 20 contains a hole or aperture 21 through which the looped chain or cord members 4 are received. Ring-form chain retainer 20 is of a size that is sufficient to prevent it from being pulled through internal passageway 13 of the elongate body 10 of shroud 9. That is, ring-form chain retainer 20 is of a sufficient size such that shroud 9 will rest upon its upper surface, effectively preventing access to the chain or cord until such time as shroud 9 is lifted vertically to expose the two opposed legs of the chain or cord.

In an embodiment of the invention ring-form chain retainer 20 maybe of a general teardrop shape, having a portion or segment 22 with a greater mass, which will help to maintain the chain retainer in a generally vertical orientation with segment 22 directed in a vertically downward position. The mass of ring-form chain retainer 20 will also tend to hold the two opposing legs of the chain or cord 4 relatively vertical and taut along the side of the window frame. In this manner, shroud 9 will be encouraged to fall, under the act of gravity, downwardly until its lower end rests upon the top of the ring-form chain retainer. The mass of the ring-form chain retainer will also help to ensure that the leg members of the looped chain or cord will remain relatively vertically-oriented when shroud 9 is grasped and slid upwardly (along the chain or cord) when seeking to expose the lower ends of the chain or cord to permit operation of the roller blind. To facilitate movement of the chain or cord through hole or aperture 21, that portion of ring-form chain retainer 20 surrounding hole or aperture 21 may be beveled or angled. Pulling on one leg of the chain or cord to operate the blind will thus permit the ring-form chain retainer to readily slide along the chain or cord without becoming caught or hung up. Further, ring-form chain retainer 20 may be formed from, or coated with, a silicone, plastic or other type material that helps to minimize the generation of noise when chain or cord 4 slides through hole or aperture 21.

While the enclosed drawings show a ring-form chain retainer 20 in the general form of a teardrop shape, it will be appreciated that a variety of other shapes and geometric configurations could equally be used while remaining within the broad scope of the invention. Further, if desired, the window frame within which blind 1 is mounted could contain a fastener or fastening mechanism that could also allow ring-form chain retainer to be releasably secured or otherwise releasably amounted to the window frame. Still further, rather than utilizing a tear drop or other such shape to enhance the mass of a portion 22 of ring-form chain retainer 20 in a manner that encourages it to hang in a desired orientation, exterior or interior weights may be utilized.

It is to be understood that what has been described are the preferred embodiments of the invention. The scope of the claims should not be limited by the preferred embodiments set forth above, but should be given the broadest interpretation consistent with the description as a whole.

I claim:

1. A shroud for a drive chain of a roller blind, the drive chain comprising a series of generally spherical balls mounted in a spaced apart configuration on a cord or wire, the drive chain in the form of a pair of chain leg members joined together and forming a loop, the shroud comprising:
an elongate body having opposed open ends with a longitudinal internal passageway extending between the opposed open ends, the elongate body having a fully enclosed exterior surface extending between the open ends,
a longitudinal internal baffle extending between the open ends and segmenting the longitudinal internal passageway into two longitudinal channels, each longitudinal channel extending between the open ends and dimensioned to slidably receive one of the pair of chain leg members therethrough,
the longitudinal internal baffle having a longitudinal slot extending along its length, the slot dimensioned to permit the receipt of the cord or wire of the drive chain therethrough, the longitudinal slot dimensioned to preclude the passage of the balls of the drive chain therethrough.

2. The shroud as claimed in claim 1 wherein the longitudinal slot is positioned in the longitudinal internal baffle to segment the baffle into two approximately equal portions, each portion secured along a longitudinal edge thereof to an internal longitudinal surface of the elongate body.

3. The shroud as claimed in claim 2 wherein the exterior surface of the elongate body is oblong and devoid of exterior corners.

4. The shroud as claimed in claim 2 in combination with a drive chain of a roller blind and a chain retainer, wherein the drive chain is received through the elongate body with one leg member extending through each of the longitudinal channels such that the leg members of the drive chain are separated by the internal baffle, wherein a lower end of each of the chain leg members extends through the same open end of the elongate body and the looped drive chain is slidably received by the chain retainer, wherein the shroud is received about the chain leg members of the drive chain between the chain retainer and a drive mechanism of the roller blind.

5. The shroud as claimed in claim 4 dimensioned to be slidable along the leg members of the drive chain from a position wherein one end of the shroud contacts the chain retainer, to a position wherein an opposite end of the shroud contacts the drive mechanism of the roller blind.

6. The shroud as claimed in claim 4 wherein the chain retainer is a ring-form chain retainer having a hole or aperture therethrough, the looped drive chain extending through the hole or aperture, the ring-form chain retainer of a dimension to prohibit it from passing into the longitudinal internal passageway.

7. The shroud as claimed in claim 6 wherein the ring-form chain retainer includes a weighted segment to encourage the ring-form chain retainer to be positioned in a pre-determined orientation and to help to maintain the drive chain leg members in a taught configuration.

8. A shroud for a drive chain or cord of a roller blind, the drive chain or cord in the form of a pair of chain or cord leg members joined together and forming a loop, the shroud comprising:
an elongate body having opposed open ends with a longitudinal internal passageway extending between the opposed open ends, the elongate body having a fully enclosed exterior surface extending between the open ends, the longitudinal passageway dimensioned to slidably receive the pair of chain or cord leg members therethrough,
wherein the pair of chain or cord leg members is receivable through the longitudinal internal passageway, wherein a lower end of each of the chain or cord leg members extends through the same open end of the elongate body and the looped chain or cord leg members is slidably received by a chain retainer, wherein the shroud is received about the chain or cord leg members between the chain retainer and a drive mechanism of the roller blind.

9. The shroud as claimed in claim 8 wherein the elongate body has a longitudinal internal baffle extending between the open ends and segmenting the longitudinal internal passageway into two longitudinal channels, each longitudinal channel extending between the open ends and dimensioned to slidably receive one of the pair of chain or cord leg members therethrough.

10. The shroud as claimed in claim 8 wherein the chain retainer is a ring-form chain retainer having a hole or aperture therethrough, the looped chain or cord leg members extending through the hole or aperture, the ring-form chain retainer of a dimension to prohibit it from passing into the longitudinal internal passageway.

11. The shroud as claimed in claim 10 wherein the ring-form chain retainer includes a weighted segment to encourage the ring-form chain retainer to hang in a pre-determined orientation and to help to maintain the chain or cord leg members in a taught configuration.

12. A shroud for a drive chain or cord of a roller blind, in combination with a chain retainer, the drive chain or cord in the form of a pair of chain or cord leg members joined together and forming a loop, the shroud comprising:
an elongate body having opposed open ends with a longitudinal internal passageway extending between the open ends, the elongate body having a fully enclosed exterior surface extending between the open ends,
the chain retainer slidably receiving the looped chain or cord leg members,
wherein the pair of chain leg members are received through the longitudinal internal passageway of the elongate body, and
wherein, when the drive or cord chain is oriented in a vertical configuration, the shroud has a resting position where it contacts the chain retainer, and a displaced position where it has been slid vertically upward along the chain or cord leg members to expose a length of the drive chain or cord between the shroud and the chain retainer.

13. The shroud in combination with a chain retainer as claimed in claim 12 wherein a longitudinal internal baffle extends between the open ends of the elongate body and segments the longitudinal internal passageway into two longitudinal channels, each longitudinal channel extending between the open ends and dimensioned to slidably receive one of the pair of chain leg members therethrough.

14. The shroud in combination with a chain retainer as claimed in claim 13 wherein the drive chain or cord is comprised of a series of generally spherical balls mounted in a spaced apart configuration on a wire or cord, wherein the longitudinal internal baffle has a longitudinal slot extending along its length, the slot dimensioned to permit the receipt of the cord or wire of the drive chain or cord therethrough, wherein the longitudinal slot is dimensioned to preclude the passage of the balls therethrough.

15. The shroud in combination with a chain retainer as claimed in claim 12 wherein the exterior surface of the elongate body is generally oblong in cross section.

16. The shroud in combination with a chain retainer as claimed in claim 12 wherein the chain retainer is a ring-form chain retainer having a hole or aperture therethrough, the looped chain or cord leg members extending through the hole or aperture, the ring-formed chain retainer of a dimension to prohibit it from passing into the longitudinal internal passageway.

17. The shroud in combination with a chain retainer as claimed in claim 16 wherein the ring-form chain retainer includes a weighted segment to encourage the ring-form chain retainer to be oriented in a pre-determined configuration and to help to maintain the chain or cord leg members in a taught configuration.
